(19) United States
(12) Patent Application Publication
(10) Pub. No.: US 2014/0326683 A1
(43) Pub. Date: Nov. 6, 2014

(54) COALESCERS AND METHODS FOR SEPARATING LIQUIDS IN AN IMMISCIBLE MIXTURE

(71) Applicant: Pall Corporation, Port Washington, NY (US)

(72) Inventors: Kyle R Kathan, Land O'Lakes, FL (US); Michael J Adams, Trinity, FL (US); Rajesh D Patel, Tampa, FL (US); Jonathan A Liddy, New Port Richey, FL (US)

(21) Appl. No.: 13/887,941

(22) Filed: May 6, 2013

(51) Int. Cl. B01D 17/02

(52) U.S. Cl. CPC B01D 17/0214
USPC 210/800; 210/519

(57) ABSTRACT

Coalescers for coalescing and methods for separating a discontinuous phase liquid, e.g., water, in an immiscible mixture of the discontinuous phase liquid and a continuous phase liquid, e.g., oil.

### DISCLOSURE OF THE INVENTION

The present invention relates to coalescers and to methods for separating liquids in an immiscible mixture. For example, oil-based liquids, including lubrication oils, may become contaminated with water. The lubrication oil may be used to lubricate the bearings of heavy machinery, e.g., large rollers in a rolling mill, and/or the work product fashioned by the machinery, e.g., slabs of metal being rolled into metal sheet. Water may be used to cool or clean the machinery and/or the work product, and this water may work its way into the lubrication system, contaminating the lubrication oil. When too much water contaminates the lubrication oil, the oil may cease to properly function as a lubricant. The bearings of the machinery may then fail due to insufficient lubrication and production may be interrupted, potentially costing hundreds of thousands of dollars in repairs and lost production time. The present invention addresses problems associated with lubrication oil contaminated with water and many other problems as well.

Oil and water are two examples of immiscible liquids, meaning liquids that do not substantially dissolve in one another when they are mixed together. One liquid, e.g., the oil, is known as the continuous phase liquid and forms the bulk of the mixture. The other liquid, e.g., the water, is known as the discontinuous phase liquid and remains entrained throughout the continuous phase liquid, generally in the form of droplets. The droplets of the discontinuous phase liquid may be regularly shaped, e.g., as spheres, or irregularly shaped, e.g., as amorphous globs or masses. The present invention allows the droplets of discontinuous phase liquid to coalesce and form much larger droplets that can easily be separated from the continuous phase liquid.

### SUMMARY OF THE INVENTION

In accordance with one aspect of the invention, coalescers are provided for coalescing a discontinuous phase liquid in an immiscible mixture of the discontinuous phase liquid and a continuous phase liquid. The coalescer may comprise a hollow, generally cylindrical body, an interior inside the hollow cylindrical body, and first and second end elements. The cylindrical body may have first and second opposite axial ends, and the first and second end elements may be disposed at the first and second axial ends of the cylindrical body, respectively. At least one of the end elements may be an open end element having an opening fluidly communicating with the interior inside the hollow cylindrical body. The end elements may direct the immiscible mixture generally radially through the cylindrical body from an upstream region of the cylindrical body to a downstream region of the cylindrical body. The cylindrical body may include a sheet of mesh having mesh openings, the mesh openings having an opening size of about 0.25 mm² or more, and the mesh sheet may be spirally wound in a plurality of windings. The spirally wound mesh sheet coalesces the droplets of the discontinuous phase liquid when the immiscible mixture passes from the upstream region to the downstream region of the cylindrical body through the mesh openings in the windings of the spirally wound mesh sheet. Larger droplets of the discontinuous phase liquid then emerge from the cylindrical body.

In accordance with another aspect of the invention, methods are provided for separating water as a discontinuous phase from an immiscible mixture of the water and oil as the continuous phase. The methods may comprise directing the immiscible mixture generally radially through a hollow, generally cylindrical body including a mesh sheet which is spirally wound in a plurality of windings and includes mesh openings having a size of about 0.25 mm² or more. Directing the immiscible mixture generally radially through the generally cylindrical body includes passing the immiscible mixture including water droplets having a first nominal size of about 0.5 mm or more into the cylindrical body, coalescing the water droplets as the immiscible mixture passes through the mesh openings in the plurality of windings of the spirally wound mesh sheet, and passing the immiscible mixture including water droplets having a larger second nominal size from the cylindrical body. Methods embodying the invention further comprise separating water from the oil after the immiscible mixture emerges from the cylindrical body.

Coalescers and methods embodying the invention have many advantageous features, including features that are highly effective for removing a discontinuous phase liquid, such as water, from a continuous phase liquid, such as oil. For example, by providing a coalescer which includes a spirally wound mesh sheet and directing the immiscible mixture through the mesh openings in the windings of the spirally wound mesh sheet, the droplets of the discontinuous phase liquid, e.g., the water droplets, are efficiently coalesced, allowing for larger droplets of the discontinuous phase liquid to emerge from the coalescer. These larger droplets of the discontinuous phase liquid are much more easily and effectively separated from the immiscible mixture. For many embodiments, the larger droplets of the discontinuous phase liquid, e.g., the larger water droplets, simply settle out of the immiscible mixture due to the effects of gravity. The continuous phase liquid, e.g., the oil, may then be returned to service containing little or no significant amount of the discontinuous phase liquid, e.g., water. For example, after the water is coalesced and separated from lubrication oil by embodiments of the invention, the lubrication oil may be used to effectively lubricate machinery without any risk that the machinery may fail and production may cease due to water contamination.

### BRIEF DESCRIPTION OF THE DRAWINGS

FIG. 1 is an isometric view of a coalescer embodying the invention.

FIG. 2 is an exploded view of the coalescer of FIG. 1.

FIG. 3 is a representative view of a fluid system embodying the invention.

### DESCRIPTION OF EMBODIMENTS OF THE INVENTION

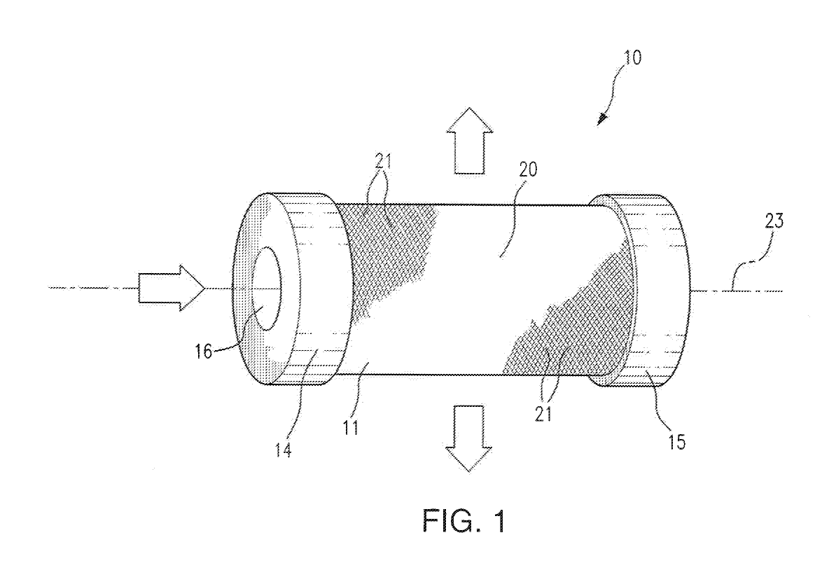

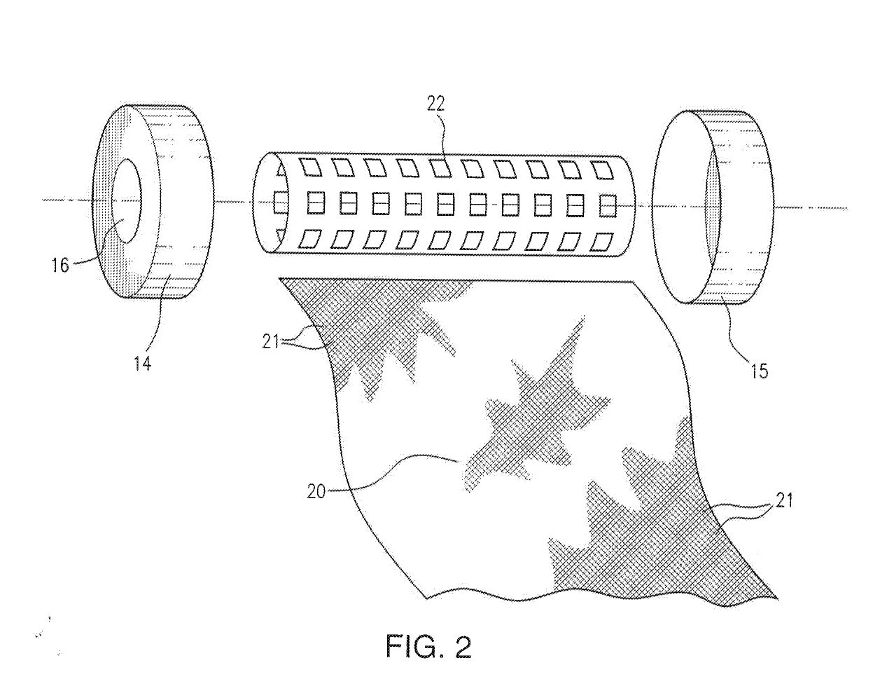

Coalescers embodying the invention may be configured in a great variety of ways. One of many different examples of a coalescer 10 embodying the invention is shown in FIGS. 1 and 2. The coalescer 10 may comprise a hollow, generally cylindrical body 11 having opposite axial ends. End elements 14, 15 may be positioned at the axial ends of the cylindrical body 11. One or both of the end elements 14, 15 may be an open end element having an opening 16 fluidly communicating with the interior of the hollow, cylindrical body 11. The cylindrical body 11 may include a sheet of mesh 20 having mesh openings 21, and the sheet of mesh 20 may be spirally wound in a plurality of windings. For many, but not all, embodiments the mesh sheet may be spirally wound around a core 22, for example, a perforated core 22. For other embodiments, the coalescer may be coreless.

An immiscible liquid mixture including a discontinuous phase liquid, e.g., water, and a continuous phase liquid, e.g., oil, may be directed through the coalescer 20 inside-out, as shown in FIG. 1, or outside-in. The end elements 14, 15 direct the immiscible mixture generally radially through the cylindrical body 11. At an upstream region of the cylindrical body 11, for example, at or near the inner periphery of the cylindrical body 11, the immiscible mixture may include smaller droplets of the discontinuous phase liquid. As the immiscible mixture passes through the mesh openings 21 in the windings of the spirally wound mesh sheet 20, the smaller droplets of the discontinuous phase liquid coalesce. From a downstream region of the cylindrical body 11, for example, at or near the outer periphery of the cylindrical body 11, the immiscible mixture emerges with larger droplets of the discontinuous phase liquid that can be easily and effectively separated from the continuous phase liquid.

The components of the coalescer may be configured in any of numerous ways. For example, for embodiments having a core, the core may be variously configured. As one example, the core 22 shown in FIG. 2 may include a hollow, perforated tube formed, for example, from a metallic or a polymeric material and having a polygonal or circular cross section. The perforations in the core 22 allow the immiscible mixture to flow from the interior of the coalescer 10 into the cylindrical body 11 or from the cylindrical body 11 into the interior of the coalescer 10, depending on the direction of flow inside-out or outside-in through the coalescer 10. Alternatively, the core may be configured in any other way that allows the immiscible mixture to flow through the cylindrical body.

The end elements may also be variously configured to direct the immiscible mixture generally radially through the cylindrical body. For example, as shown in FIGS. 1 and 2, each end element 14, 15 may comprise an end cap formed, for example, from an impervious metallic or polymeric material. The opening 16 in the end element(s) or end cap(s) may he an inlet or an outlet, depending on the direction of flow inside-out or outside-in through the cylindrical body 11, and allows the immiscible mixture to flow into or out of the coalescer 10 via the interior of the coalescer 10. The opening 16 may be a simple hole or it may be configured as a fitting which allows the coalescer to be connected to another component. The first and second end caps 14, 15 may be respectively bonded to the first and second axial ends of the cylindrical body 11 and/or the core 22 in a variety of ways to seal the ends of the cylindrical body. For example, the end caps may be spin bonded, adhesively bonded, solvent bonded, or polycapped to the ends of the cylindrical body and/or the core. Alternatively, the end elements may comprise a bonding composition applied to the windings of the mesh sheet at the ends of the cylindrical body and/or the core to seal the ends of the cylindrical body. The end elements may be configured in any other way that seals the ends of the cylindrical body and directs the flow of the immiscible mixture radially through the cylindrical body.

The generally cylindrical body may be configured in any of numerous ways. For example, the cylindrical body 11 may have a longitudinal axis 23 and a polygonal or circular cross section. For embodiments having a core 22, the core 22 and the cylindrical body 11 may have similarly shaped cross sections. The cylindrical body may have a plurality of radially distinct sections, including, for example, a radially innermost section, a radially outermost section, and one or more radially intermediate sections. At least one of the sections may include a spirally wound mesh sheet. The other sections may include spirally wound sheets or cylindrical sleeves of similar or different materials, including, for example, mesh sheets having differently sized openings; coarsely porous woven or non woven, including knitted, sheets; or coarsely porous cylindrical fibrous sleeves.

However, for many embodiments, the cylindrical body 11 may have only one radial section, which includes the spirally wound mesh sheet 20. For example, the spirally wound mesh sheet 20 may be the sole component of the cylindrical body 11. The spirally wound mesh sheet 20 may be wound in a plurality of windings to form the cylindrical body 11. The inner most winding of the mesh sheet 20 may comprise the inner periphery of the cylindrical body 11, and the outermost winding of the mesh sheet 20 may comprise the outer periphery of the cylindrical body 11. From the innermost winding to the outermost winding, adjacent windings of the mesh sheet 20 may contact one another. For embodiments having a core 22, the innermost winding of the mesh sheet 20 may contact and/or may be bonded to the outer periphery of the core 22, and the mesh sheet 20 may be spirally wound around the core 22. For embodiments without a core, the mesh sheet may be spirally wound around a mandrel and then removed from the mandrel before the end elements are positioned at the axial ends of the cylindrical body. The mesh sheet 20 may be spirally wound in any number of windings and to any desired radial dimension. For example, the spirally wound mesh sheet 20 may have a radial dimension in the range from about 1 cm or less to about 5 cm or more.

The mesh sheet may be configured in any of a variety of ways. The mesh sheet may comprise any type of mesh, including an extruded, expanded, or woven mesh, netting, or apertured sheet and may be fashioned from a metallic or polymeric material. Suitable polymers include any of various Nylons, Teflons, polyesters, and PPS. The mesh sheet may be fashioned from, or treated to be, a liquiphilic (e.g., aquaphilic or oleophilic) material or a liquiphobic (e.g., aquaphobic or oleophobic) material. The mesh sheet may be a multilayer composite, including layers having similar or different characteristics. For example, the mesh sheet may comprise a composite of two or more layers of similar or identical mesh. However, for many embodiments, the mesh sheet 20 may be a single layer structure. For example, the mesh sheet may be a single layer of extruded polymeric mesh.

The mesh sheet may be relatively coarse and the openings in the mesh may be relatively large. For example, the mesh openings may have an opening size, e.g., a pore size or hole size, of about 0.25 mm² or more, e.g., in the range from about 0.25 mm² to about 4 mm² or more. The mesh sheet may have a strand count of about 10 strands per inch (2.54 cm) or more in each direction, may have any desired angle between intersecting strands, and may be symmetric or asymmetric. For many embodiments, the mesh sheet may have a strand count in the range from about 15×15 strands per inch to about 30×30 strands per inch, may have an opening size in the range from about 0.4 mm² to about 2.5 mm², and may have a diamond or square opening pattern.

A coalescer may include any number of additional components. For example, a perforated cylindrical cage may be mounted around the outer periphery of the cylindrical body. The cage may provide additional structural integrity to the coalescer and additional support against any forces associated with fluid flow inside-out through the cylindrical body.

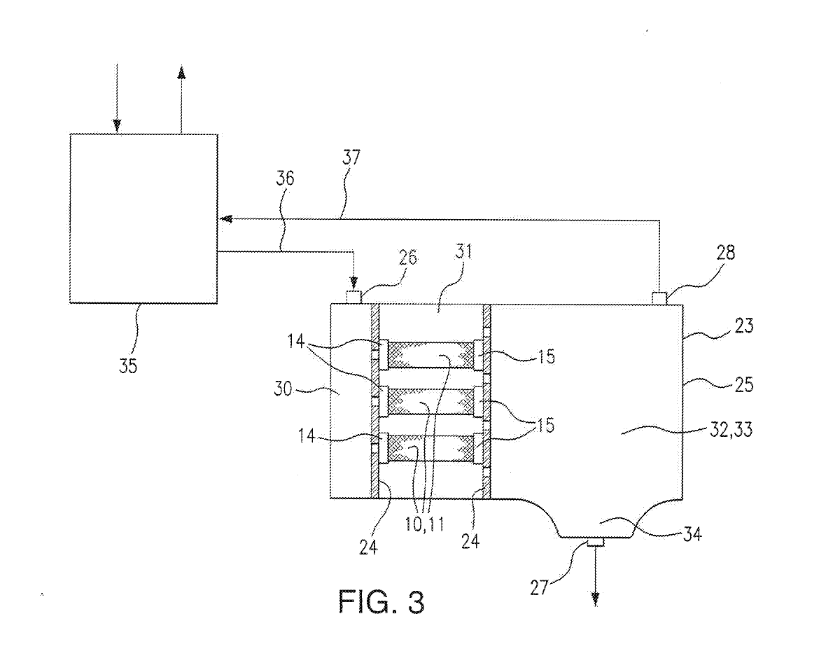

One or more coalescers 10 may be mounted in a housing 23 by any of a variety of support structures 24 to form a coalescer assembly 25, as shown, for example, in FIG. 3. The housing may be configured in any of numerous ways and may be fashioned from any material, e.g., a metallic material, capable of withstanding the temperatures and pressures of the immiscible mixture. The coalescers may be removably mounted to the support structure, for example, as a bank of replaceable coalescer cartridges, and may have any desired axial length. For example, the coalescers may have an axial length in the range from about 4 inches (10 cm) or less to about 60 inches (1.5 m) or more, e.g., from about 10 inches (0.25 m) to about 40 inches (1 m). The coalescers may be mounted to the support structure within the housing horizontally, vertically, or at any angle between horizontal and vertical.

For many embodiments, the housing may comprise a horizontally disposed pressure vessel and may include an inlet fluidly communicating with the upstream region of each coalescer and at least one outlet fluidly communicating with the downstream region of the coalescer. For example, the housing 23 may include an immiscible mixture inlet 26; a discontinuous phase liquid outlet 27, e.g., a water outlet; and a continuous phase liquid outlet 28, e.g., an oil outlet. The support structure 24 may define upstream and downstream chambers 30, 31 within the housing 23, the upstream chamber 31) fluidly communicating between the immiscible mixture inlet 26 and the upstream regions, e.g., the inner peripheries, of the coalescers 10 and the downstream chamber 31 fluidly communicating between the downstream regions, e.g., the outer peripheries, of the coalescers 10 and the discontinuous phase liquid outlet 27 and the continuous phase liquid outlet 28. The coalescers 10 may be mounted to the support structure 24, e.g., horizontally mounted, between the upstream and downstream chambers 30, 31 for inside-out or outside-in flow. For example, each coalescer 10 may have an open end element 14 on one end and a blind end element 15 on the opposite end. The openings 16 in the open end elements 14 may serve as coalescer inlets allowing the immiscible mixture to pass from the upstream chamber 30 into the interiors of the coalescers 10 and then inside-out through cylindrical bodies 11 of the coalescers 10 into the downstream chamber 31.

The coalescing assembly 25 may further include a separating region 32 in the downstream chamber 31 of the housing 23, the separating region 32 separating the discontinuous phase liquid, e.g., the water, from the continuous phase liquid, e.g., the oil, of the immiscible mixture. The separating region may be configured in any of numerous ways. For example, the separating region may include elements having a porous separating medium that allows one of the discontinuous phase and continuous phase liquids to pass through the medium but resists passage of the other liquid through the medium. In other embodiments, the separating region may comprise a settling region that slows the flow of the immiscible mixture and allows the continuous phase and discontinuous phase liquids to separate from one another due to the effects of density and gravity. For example, as shown in FIG. 3, the separating region 32 may comprise a settling region 33 in the housing 23 which has sufficient volume to slow the rate of flow of the immiscible mixture and allow the higher density liquid to settle out of the immiscible mixture and sink below the lower density liquid. In the illustrated embodiment, the discontinuous phase liquid, e.g., the water, may be the higher density liquid, while the continuous phase liquid, e.g., the oil, may be the lower density liquid. After being coalesced by the coalescers 10, the larger droplets of water quickly and easily settle to the bottom of the settling region 33, while the oil remains above the water. The housing 23 may include a trap 34, e.g., a water trap, to collect the settled higher density water. The discontinuous phase liquid outlet 27 may be positioned at or near the bottom of the housing 23, e.g., in the trap 34, to withdraw the discontinuous phase liquid, e.g., the water. The continuous phase liquid outlet 28 may be positioned on the housing 23 above the discontinuous phase liquid outlet 27, e.g., at or near the top of the housing 23, to withdraw the continuous phase liquid, e.g., the oil.

Methods for separating a discontinuous phase liquid from an immiscible mixture of the discontinuous phase liquid and a continuous phase liquid may be embodied in numerous ways. For example, the methods may comprise separating water as a discontinuous phase in an immiscible mixture of water and oil, e.g., lubrication oil, as a continuous phase. For many of these embodiments, the oil may be somewhat viscous, and the water may initially be entrained in the oil in the form of somewhat large water droplets. For example, the oil may have viscosity in the range from about 100 centistokes or less to about 1000 centistokes or more. The water may be in the form of a distribution of water droplets having a nominal size of about 0.5 mm or more. Further, the water may comprise about 2% or more by volume, e.g., anywhere from about 2% to about 10% or more by volume, of the immiscible mixture.

Methods for separating the water may comprise directing the immiscible mixture of water as a discontinuous phase and oil as the continuous phase generally radially through a hollow, generally cylindrical body. The cylindrical body includes a mesh sheet which is spirally wound in a plurality of windings and which includes mesh openings having an opening size of about 0.25 mm² or more. Directing the immiscible mixture through the cylindrical body may include passing the immiscible mixture including water droplets having a first nominal size of about 0.5 mm or more into the cylindrical body, coalescing the water as the immiscible mixture passes through the mesh openings in the windings of the spirally wound mesh sheet, and passing the immiscible mixture including water droplets having a larger second nominal size from the cylindrical body.

For example, the immiscible mixture including the first nominally sized water droplets in oil may be directed into the coalescer assembly containing the coalescers. In the embodiment shown in FIG. 3, the immiscible mixture may be pumped from a source 35 of the mixture, e.g., a reservoir of a lubrication system containing the mixture, and delivered along a feed line 36 to the immiscible mixture inlet 26 of the coalescer assembly 25. From the inlet 26, the immiscible mixture may be directed to the coalescers 10, e.g., via the upstream chamber 30, and passed generally radially through the cylindrical bodies 11 of the coalescers 10. For example, the immiscible mixture including the first nominally sized water droplets may pass from the upstream chamber 30 through the openings 16 in the open end elements 14 into the interiors of the coalescers 10. The immiscible mixture may then pass generally radially inside-out from the downstream region, e.g., the inner periphery, through the mesh openings in the windings of the mesh sheet 20 to the upstream region, e.g., the outer periphery, of each cylindrical body 11. As the immiscible mixture passes through the mesh openings, the water coalesces. The immiscible mixture then emerges from the downstream region of the cylindrical body 11 with water droplets having a distribution of sizes characterized by a second nominal size larger than the first nominal size. For example, the immiscible mixture with water droplets having a second nominal size of about 5 mm or more or 10 mm or more may emerge from the cylindrical body of each coalescer 10.

Methods embodying the invention may further comprise separating the water from the immiscible mixture. For example, the water may be separated from the immiscible mixture within the coalescer assembly 25. In the embodiment shown in FIG. 3, the immiscible mixture may emerge from the cylindrical bodies 11 of the coalescer 10 and meter a separating region 32 in the downstream chamber 31 inside the housing 23 of the coalescer assembly 25. The separating region 32 may, for example, comprise a settling region 33 which has a sufficient volume to slow the rate of flow of the immiscible mixture and allow the water droplets to separate from the oil by settling to the bottom of the housing 23, e.g., into the water trap 34. The water may then be discharged from the housing 23 of the coalescer assembly 25 via the discontinuous phase outlet 27. The oil, which contains little or no free water, e.g., less than about 2% or less than about 1% water by volume, may then be discharged from the housing 23 of the coalescer assembly 25 via the continuous phase outlet 28. For many embodiments, the oil may be returned to the lubrication system, e.g., to the source 35 via a return line 37, and the water may be purified and/or recycled.

### EXAMPLE

This example describes one of numerous different embodiments of the invention, and while this example illustrates many of the advantageous features of the invention, it does not limit the invention in any way.

A cylindrical body of a coalescer is formed by spirally winding seven linear feet (2 m) of a four-inch (10 cm) wide mesh sheet in a plurality of windings around a perforated core. The mesh sheet is a symmetric extruded Nylon mesh having a 20×20 strand count and a strand thickness of 0.0091 inch (0.23 mm). The mesh openings have a diamond pattern, and the size of the mesh openings in the mesh sheet is 0.83 mm². The outer diameter of the core is one inch (2.5 cm) and the outer diameter of the spirally wound mesh sheet is two inches (5 cm). The axial ends of the cylindrical body are sealed with a hot melt sealant and end capped.

Immiscible mixtures of Mobil Vacuoline 137 oil and water are passed generally radially inside out through the windings of the mesh sheet of the coalescer at flow rates between 0.8 and 1.2 lpm. In the influent immiscible mixtures, the viscosity of the oil is greater than 500 cSt at room temperatures, the water concentration is between 2% and 5% by volume, and the water is in the form of water droplets having a nominal size between 1 and 2 mm. In the effluent immiscible mixtures, the water emerges from the cylindrical body of the coalescer in the form of water droplets having a nominal size greater than 10 mm, and the water quickly separates from the oil by settling. The free water concentration in the separated oil is less than 1% for all of the influent water concentrations.

Although the invention has been disclosed in the embodiments previously described and/or illustrated, the invention is not limited to those embodiments. For instance, one or more features of an embodiment may be eliminated or modified, one or more features of one embodiment may be combined with one or more features of other embodiments, or embodiments with very different features may be envisioned without departing from the scope of the invention. For example, one or more seals, e.g., O-ring seals, may be provided at the openings in the open end cap of each coalescer to facilitate sealing each coalescer to the support structure. As another example, the separating region may be eliminated from the coalescer assembly and positioned in a separate housing, e.g., a separate settling tank, downstream from the coalescer assembly. The coalescer assembly may then have only one outlet for discharging the immiscible mixture including the larger coalesced water droplets to the settling tank. As yet another example, a filter assembly may be associated with the coalescer assembly. For example, the filter assembly may be positioned in the return line downstream from the coalescer assembly to filter particulates from the continuous phase e.g., the oil, separated from the immiscible mixture.

The present invention thus encompasses innumerable embodiments and is not restricted to the embodiments that have been described, illustrated, and/or suggested herein. Rather, the invention includes all embodiments and modifications that may fall within the scope of the claims.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as” or “e.g.”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A coalescer for coalescing a discontinuous phase liquid in an immiscible mixture of the discontinuous phase liquid and a continuous phase liquid, the coalescer comprising a hollow generally cylindrical body, an interior inside the hollow cylindrical body, and first and second end elements, the cylindrical body having first and second opposite axial ends and the first and second end elements being disposed at the first and second opposite axial ends of the cylindrical body, at least one of the first and second end elements being an open end element having an opening fluidly communicating with the interior inside the hollow cylindrical body, wherein the end elements direct the immiscible mixture generally radially through the cylindrical body from an upstream region to a downstream region of the cylindrical body, the cylindrical body including a sheet of mesh having mesh openings, the mesh openings having an opening size of about 0.25 mm² or more, and the mesh sheet being spirally wound in a plurality of windings, wherein the spirally wound mesh sheet coalesces the droplets of the discontinuous phase liquid when the immiscible mixture passes from the upstream region to the downstream region of the cylindrical body through the mesh openings in the windings of the spirally wound mesh sheet, larger droplets of the discontinuous phase liquid emerging from the cylindrical body.

2. The coalescer of claim 1 wherein the mesh sheet comprises an extruded polymeric mesh.

3. The coalescer of claim 2 wherein the extruded polymeric mesh has a strand count of about 10×10 or more.

4. The coalescer of claim 1 wherein the spirally wound mesh sheet has an innermost winding, an outermost winding, and one or more intermediate windings between the innermost winding and the outermost winding, wherein the cylindrical body has an inner periphery and an outer periphery, wherein the innermost winding of the mesh sheet defines the inner periphery of the cylindrical body and the outermost winding of the mesh sheet defines the outer periphery of the cylindrical body, and wherein adjacent windings of the spirally wound mesh sheet contact one another.

5. The coalescer of claim 4 wherein the mesh sheet comprises only a single layer.

6. The coalescer of claim 4 further comprising a core situated along the inner periphery of the cylindrical body, wherein the innermost winding of the spirally wound mesh sheet contacts the core.

7. The coalescer of claim 1 further comprising a core, wherein the cylindrical body has an inner periphery and the core situated along the inner periphery of the cylindrical body.

8. The coalescer of claim 1 wherein the end elements each comprise an end cap.

9. The coalescer of claim 1 wherein the mesh openings have an opening size in the range from about 0.25 mm² to about 4 mm².

10. A coalescer assembly comprising a housing and at least one coalescer of claim 1 positioned in the housing, the housing having an inlet fluidly communicating with the upstream region of the cylindrical body and an outlet fluidly communicating with the downstream region of the cylindrical body.

11. The coalescer assembly of claim 10 wherein the one or more coalescers are mounted horizontally in the housing.

12. The coalescer assembly of claim 10 the discontinuous phase liquid comprises water and the continuous phase liquid comprises oil, wherein the housing includes a water trap downstream from the one or more coalescers to trap water coalesced by the coalescers, and wherein the outlet comprises a water outlet in the water trap and an oil outlet above the water outlet.

13. A method for separating water as a discontinuous phase in an immiscible mixture of the water and oil as a continuous phase, the method comprising directing the immiscible mixture generally radially through a hollow, generally cylindrical body including a mesh sheet spirally wound in a plurality of windings and including mesh openings having an opening size of about 0.25 mm² or more, wherein directing the immiscible mixture generally radially through the hollow, generally cylindrical body includes passing the immiscible mixture including water droplets having a first nominal size of about 0.5 mm or more into the cylindrical body, coalescing the water droplets as the immiscible mixture passes through the mesh openings in the windings of the spirally wound mesh sheet, and passing the immiscible mixture including water droplets having a larger second nominal size from the cylindrical body, and separating water from the oil after the immiscible mixture emerges from the cylindrical body.

14. The method of claim 13 wherein directing the immiscible mixture through the cylindrical body includes directing the immiscible mixture inside-out through the cylindrical body.

15. The method of claim 13 wherein separating water from oil includes settling the water from the oil.

16. The method of claim 13 wherein directing the immiscible mixture through the cylindrical body includes directing the immiscible mixture through a plurality of cylindrical bodies of a plurality of coalescers in a housing of a coalescer assembly.

17. The method of claim 16 wherein separating the water from the oil includes separating the water from the oil in a separating region in the housing of the coalescer assembly.
